(19) United States
(12) Patent Application Publication
(10) Pub. No.: US 2011/0094981 A1
(43) Pub. Date: Apr. 28, 2011

(54) APPARATUS AND METHOD FOR UTILIZING A GRAVITY FEED HANGER

(75) Inventor: Joseph M. BATTAGLIA, Frisco, TX (US)

(73) Assignee: FRITO-LAY NORTH AMERICA, INC., Plano, TX (US)

(21) Appl. No.: 12/983,588

(22) Filed: Jan. 3, 2011

Related U.S. Application Data
(62) Division of application No. 11/832,346, filed on Aug. 1, 2007, now Pat. No. 7,882,964.

(51) Int. Cl. A47F 1/04; B23P 11/00

(52) U.S. Cl. 211/59.2; 29/428

(57) ABSTRACT

An apparatus and method for removably coupling a hanger to a latch at a first end of the hanger, removing the hanger from the latch while the latch remains coupled to a support member, threading an item of hanging stock onto the hanger via the first end, and recoupling the hanger to the latch while the latch remains coupled to the support member, wherein the hanger extends from the latch at an angle that is less than the horizontal, so that the hanging stock is urged by gravity toward a second end of the hanger.

### BACKGROUND

The present disclosure relates in general to inventory management systems and in particular to gravity feed hangers for displaying and dispensing hanging stock.

### BRIEF DESCRIPTION OF THE DRAWINGS

FIG. 1 is a perspective front view of a gravity feed system according to one embodiment of the present disclosure.

FIG. 2 is an enlarged perspective and exploded view of a gravity feed hanger assembly of the gravity feed system of FIG. 1.

FIG. 3 is an enlarged perspective view of a latch of the gravity feed hanger assembly depicted in FIG. 2.

FIG. 4 is a perspective view of the hanger of FIG. 2 being threaded through hanging stock loaded in a stock container.

FIG. 5 is a perspective view of the hanging stock from FIG. 4 being removed from a stock container after being threaded onto the hanger of FIG. 2.

FIGS. 6-10 are perspective views, in series, of the hanger and latch of the gravity feed hanger assembly of FIG. 2 being coupled.

FIG. 11 is a perspective front view of the gravity feed assembly of FIG. 2, loaded with hanging stock.

FIG. 12 is a side elevation of the loaded gravity feed assembly of FIG. 11.

FIGS. 13-15 are perspective views, in series, of the removal of the hanging stock and the operation of the gravity feed system of FIG. 1.

FIG. 16 is a perspective view of a hanger according to one embodiment of the present disclosure.

FIG. 17 is a perspective view of the hanger of FIG. 16 loaded with hanging stock.

FIG. 18 is a perspective view of a hanger according to one embodiment of the present disclosure.

FIG. 19 is a perspective view of the hanger of FIG. 18 loaded with hanging stock.

FIG. 20 is a partial perspective and partial sectional view of a latch according to one embodiment of the present disclosure.

FIG. 21 is a perspective view of a gravity feed hanger assembly bearing a barcode display according to one embodiment of the present disclosure.

FIG. 22 is a perspective view of the actuated barcode display of FIG. 21.

FIG. 23 is a side elevation of the gravity feed hanger assembly of FIG. 21.

FIG. 24 is a side elevation of a gravity feed hanger assembly including a varied-angle hanger according to one embodiment of the present disclosure.

### DETAILED DESCRIPTION

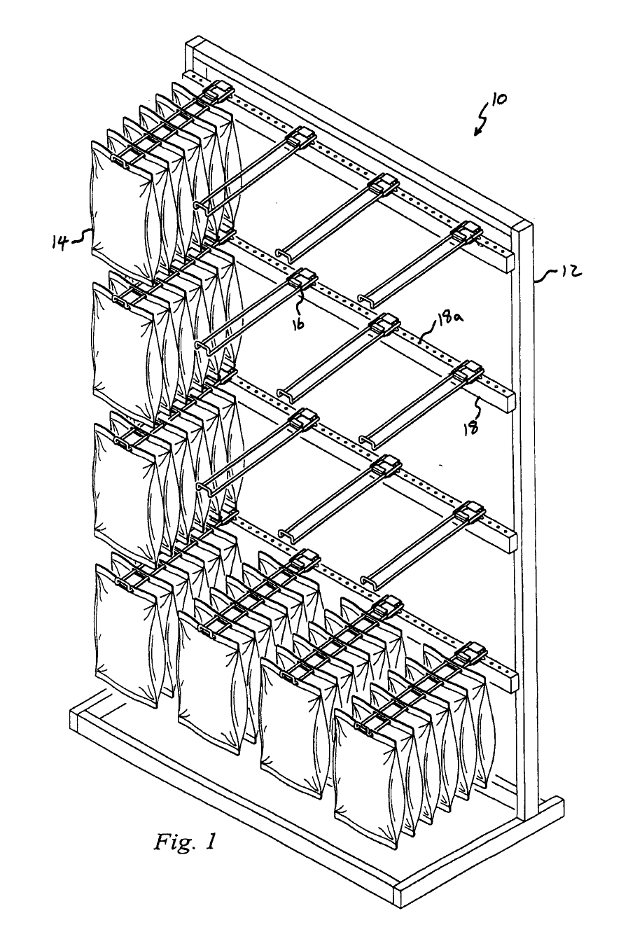

Referring to FIG. 1, a gravity feed system according to an embodiment of the invention is referred to, in general, by the reference numeral 10. The gravity feed system 10 includes a display apparatus 12, upon and from which a multitude of hanging stock 14 may be displayed and dispensed, respectively. The hanging stock 14 are supported by multiple gravity feed hanger assemblies 16, which are in turn supported by crossbeams 18.

Although the hanging stock 14 depicted in the Figs. includes average-sized flex-bags, which are most commonly suited to the marketing of snack foods, the gravity feed system 10 can be used to store and dispense other items packaged in bags, boxes, or other similar containers. As shown in FIG. 1, the hanging stock 14 engages the gravity feed hanger assembly 16 via a slot 20 formed in the hanging stock tab 22. In other embodiments, this engagement can be obtained through the use of a non-integral tab added to the hanging stock 14 prior to placement of the hanging stock 14 on the gravity feed hanger assembly 16. In still further embodiments, the hanging stock 14 may comprise an integral or attached hook for engaging the gravity feed hanger assembly 16.

The configuration of the gravity feed system 10 can be rearranged to suit a variety of sizes and shapes of hanging stock 14. In the embodiment shown in FIG. 1, the configuration of the gravity feed system 10 is determined by the vertical spacing of the crossbeams 18 and the horizontal spacing of the gravity feed hanger assemblies 16 along each crossbeam. In some embodiments, the crossbeams 18 are removably coupled with the upright portion of the display apparatus 12 so that the vertical position of each crossbeam 18 is adjustable along generally the entire length of the upright portions of the display apparatus 12. Each crossbeam 18 also contains a uniformly spaced linear array of vertically oriented receptacles 18a that extend through the crossbeam 18. The array of receptacles 18a extends substantially the length of the crossbeam 18.

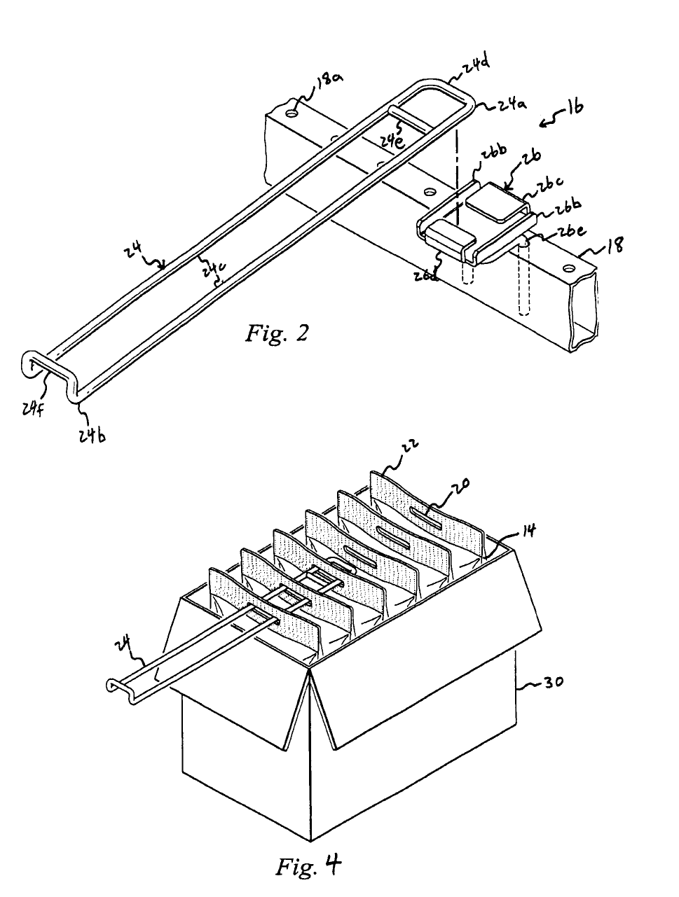

Referring to FIG. 2, the gravity feed hanger assembly 16 comprises a hanger 24 and a latch 26 which are configured to be removably coupled together and, when so coupled, interact to support and dispense the hanging stock 14. The hanger 24 has a loading end 24a and a dispensing end 24b and includes a pair of parallel rods 24c that substantially define the length of the hanger 24. The amount of space between the rods 24c can be varied, based on the weight and dimensions of the hanging stock 14.

The hanger rods 24c are connected at the loading end 24a of the hanger 24 by an endpiece 24d that extends from the ends of each of the rods 24c. A crosspiece 24e similarly extends between the hanger rods 24, in parallel with the endpiece 24d, and is spaced from the endpiece 24d as required by the fit of the hanger 24 with the latch 26, described herein. In some embodiments, the hanger 24 may include only one of the endpiece 24d and the crosspiece 24e, or the endpiece 24d or the crosspiece 24e may not completely span the gap between the hanger rods 24c. Some embodiments of the hanger may possess rounded joints between the endpiece and the hanger rods, so as to facilitate insertion of the hanger in to the latch, as described herein.

The hanger rods 24c are connected at the dispensing end 24b by a lip 24f which curls upward. In some embodiments, the lip 24f bends back toward the rods 24c to form an angle of 90-degrees or less with the rods 24c. In some embodiments, the lip 24f is bent back such that it is substantially vertical. The hanger rods 24c, the lip 24f and the endpiece 24d can be formed from a single piece of material, such as wiring or molded plastic. In other embodiments, the components of the hanger 24 may be distinct and thus assembled to form the hanger 24.

Referring to FIG. 3, with continuing reference to FIG. 2, the latch 26 of the gravity feed hanger assembly 16 includes a base 26a, two longitudinal side tabs 26b, a latitudinal load tab 26c, a latitudinal restraining tab 26d, and a pair of mounting members 26e. The base 26a, which is flat and rectangular, has a top face 26aa, which defines the plane along which the hanger 24 extends, a bottom face 26ab, side edges 26ac, a front edge 26ad and a rear edge 26ae. The side tabs 26b extend upward from the side edges 26ac of the base 26a to a height at least equal to the thickness of the rods 24c, so that the side tabs 26b are parallel to each other and perpendicular to the base 26a. The restraining tab 26d extends upward from the front edge 26ad of the base 26a to a height generally equal to that of the side tabs 26b, and then extends, parallel to the top face 26aa and toward the rear edge 26ae of the base 26a, for a distance at least equal to the thickness of the crosspiece 24e. The load tab 26c extends from the rear edge 26ae of the base 26a and mirrors the restraining tab 26b with the exception that the horizontal portion of the load tab 26c extends further, so that the gap between the load tab 26c and the restraining tab 26b is no greater than the space between the endpiece 24d and crosspiece 24e of the hanger 24.

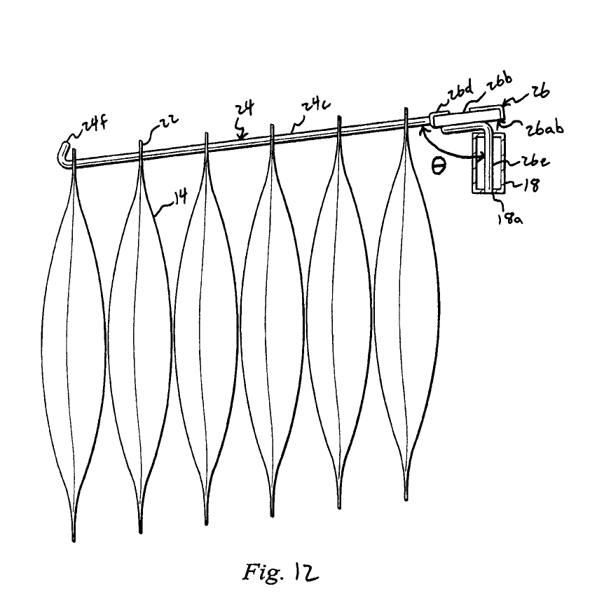

The mounting members 26e extend in parallel from the bottom face 26ab of the base 26a at an angle dictated by the desired resting angle of the mounted gravity feed hanger assembly 16. As demonstrated by the embodiment illustrated in FIG. 12, the mounting members 26e may be angled, with respect to the bottom face 26ab, such that the hanger 24 extends away from the crossbeam 18 at a downward angle. In some embodiments, the hanger 24 extends from the crossbeam 18 such that an angle θ between the mounting members 26e and the hanger 24 is about 80 degrees. In other embodiments, the angle of the gravity feed hanger assembly 16 may be adjusted to be more level or more sloped with respect to a horizontal plane. The mounting members 26e may be distinct components or, as illustrated in FIGS. 2 and 12, they may both be formed from a single, continuous piece of material.

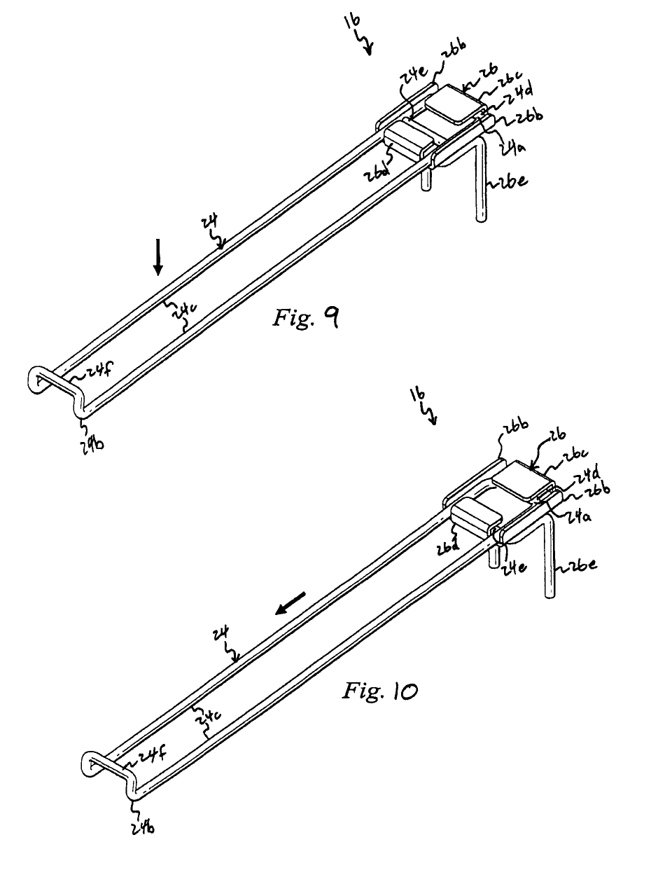

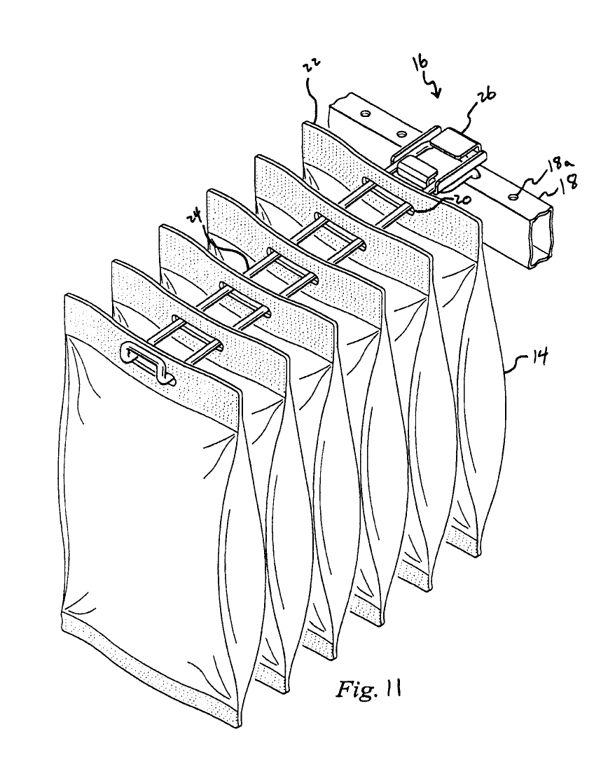

When an embodiment of the gravity feed system 10 is in an assembled and installed condition, as shown in FIGS. 1 and 11, the gravity feed hanger assembly 16 is mounted on the crossbeam 18. As shown in FIGS. 2 and 12, the mounting members 26e are inserted into the receptacles 18a of the crossbeam 18 and extend substantially through the vertical length of the crossbeam 18, so that the latch 26 is stabilized against lateral and longitudinal movement. As demonstrated in FIGS. 10 and 11, the hanger 24 is coupled with the latch 26 such that the crosspiece 24e is substantially enclosed by the restraining tab 26d, the endpiece 24d is covered by the load tab 26c, and the rods 24c are flanked by the side tabs 26b. As illustrated by FIGS. 1 and 11, the gravity feed system 10 is thus suited to support the hanging stock 14 that is suspended from the hanger 24.

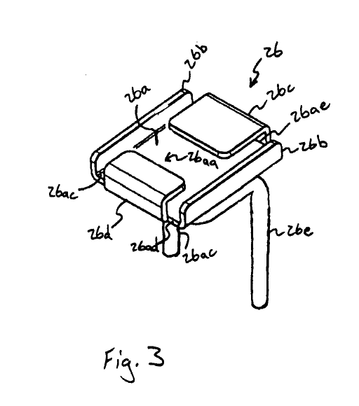

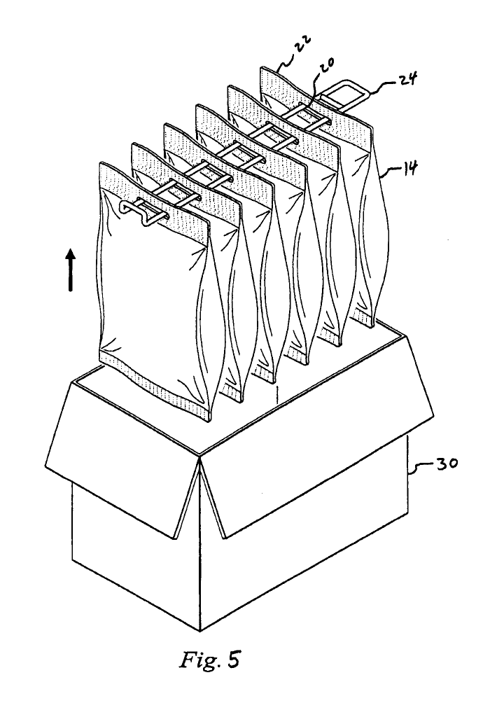

Operationally, the gravity feed system 10 is also suited to the time- and movement-efficient stocking, controlled dispensing and restocking of the hanging stock 14. Referring to FIGS. 4 and 5, the hanging stock 14 can provided in stock containers 30 that allow the hanging stock 14 to arrive at the point of sale in a condition such that the hanging stock 14 is aligned in the same configuration in which it will be displayed in the gravity feed system 10. In the embodiment shown, the hanger 24, decoupled from the latch 26, is threaded through the hanging stock tabs 22 of the hanging stock 14 via the slots 20. The loading end 24a of the hanger 24 is substantially linear and coplanar with the rest of the hanger 24, ensuring that multiple items of hanging stock 14 may be threaded onto the hanger 24 in one continuous motion. The entirety of the hanging stock 14 to be displayed and dispensed from the hanger 24 is then removed from the stock container 30 by exerting sufficient upward force on the hanger 24.

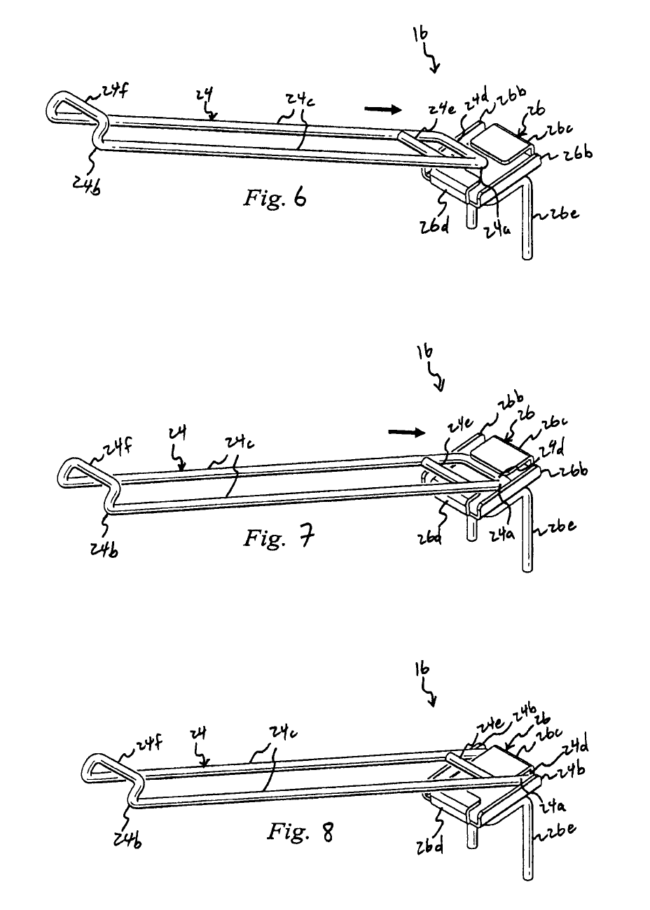

FIGS. 6-10 are perspective views of the hanger 24 and the latch 26 in a series, according to an aspect of the present disclosure, with continued reference to FIG. 3, and show the coupling of the hanger 24 to the latch 26. The endpiece 24d of the hanger is inserted into the gap between the load tab 26c and the restraining tab 26b so that it contacts the top face 26aa of the base 26a. The endpiece 24d is then slid toward the rear edge 26ae of the latch 26 (and, in the case of the embodiment displayed, upward, due to the downward angle at which the gravity feed hanger assembly 16 will rest) until the endpiece 24d also contacts the portion of the load tab 26c that is perpendicular to the base 26a. The hanger 24 is then rotated downward, about the endpiece 24d, so that the crosspiece 24e contacts the top face 26aa of the base 26a and the hanger 24 extends from the latch 26 along substantially the same plane as that defined by the top face 26aa. An outward (and, for this embodiment, downward) force is exerted on the hanger 24 so that it slides within the latch 26, in the direction of the front edge 26ad, and the crosspiece 24e contacts the portion of the restraining tab 26d that is perpendicular to the top face 26aa.

Thus coupled with the latch 26, as shown in FIGS. 10 and 11, the hanger 24 allows for the display and dispensing of the hanging stock 14. The latch 26 stabilizes the hanger 24 against most lateral, longitudinal, and even upward and downward movement. As the weight of the hanging stock 14, as well as that of the hanger 24 itself, exerts outward and downward forces on the hanger 24 that pin the crosspiece 24e against the load tab 26c and the top face 26aa of the latch 26, the crosspiece 24e acts as a fulcrum and translates the downward force exerted by the hanging stock 14 into an upward force that is exerted on the endpiece 24d. The endpiece 24d is held in place, and thus the hanger 24 is prevented from rotating about the crosspiece 24e, by the restraining tab 26b. The gap between the load tab 26c and the restraining tab 26b is sized to ensure that, in order to decouple the hanger 24 from the latch 26, the crosspiece 24e must be forced away from the horizontal portion of the restraining tab 26b and toward the gap between the restraining tab 26b and the load tab 26c.

Due to the downward angle at which the gravity feed hanger assembly 16, and thus the hanger 24, extends from the crossbeam 18 in the embodiment shown, the weight of the hanging stock 14 also tends to pull the hanging stock 14 down the length of the hanger 24, absent sufficient friction between the hanging stock tab 22 and the rods 24c to prevent slippage. In some embodiments, the hanger 24 may be powder-coated or otherwise treated with a friction-reducing product so as to facilitate the movement of the hanging stock 14 along the hanger 24. Such products may contain, for example, Teflon or materials with similar low-friction properties. One example of such material is the Sliptex powder coating manufactured by Prism Powder Coating Ltd. However, other materials are also within the scope of the present disclosure.

Despite the force exerted on the hanging stock 14 by its own weight, the lip 24f prevents the uncontrolled dispensing of hanging stock 14 by halting the progress of the foremost item of hanging stock 14 at the dispensing end 24b of the hanger 24. As shown in FIG. 12, the lip 24f is long enough and set at an angle sufficient to prevent the hanging stock 14 from being propelled off of the end of the hanger 24 by the force of its own weight, in combination with the cumulative weight of any of the hanging stock 14 that may be trailing behind it.

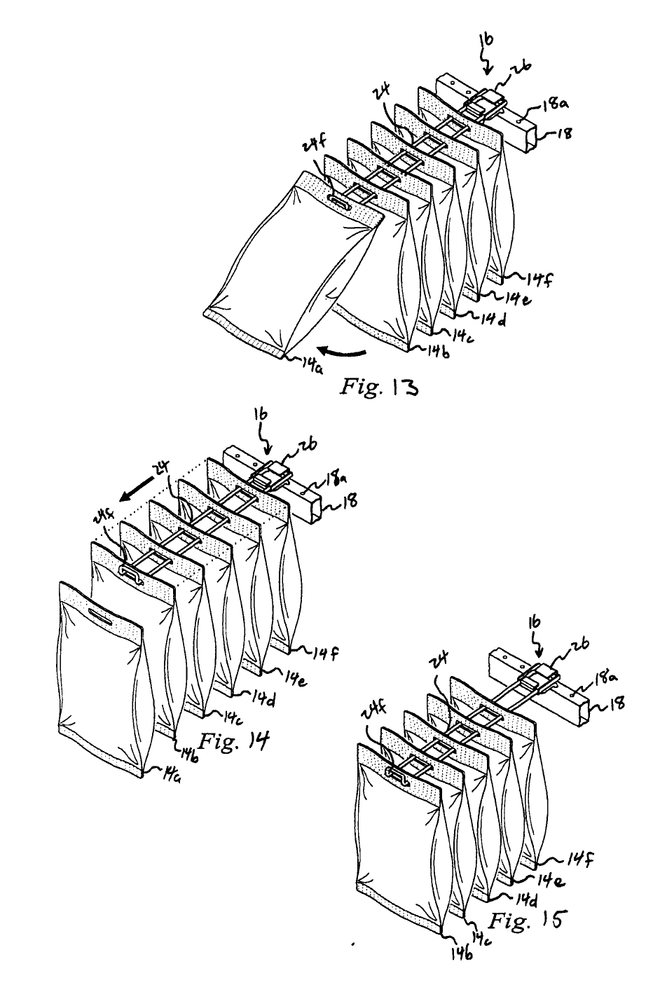

Controlled dispensing of the hanging stock 14 is performed by the manual removal of the hanging stock 14. In the embodiment illustrated in FIGS. 13-15, a foremost item 14a must be manipulated by the individual removing it so that it is pulled both outward and upward, clearing the lip 24f. As the item 14a vacates its position at the bottom of the hanger 24, trailing hanging stock 14b-14f are pulled downward, along the hanger 24, by their own weight. Once the hanging stock 14a has been removed entirely from the hanger 24, the hanging stock 14b, no longer impeded by the obstructing hanging stock 14a, is urged by its own weight to the end of the hanger 24 and is halted by the lip 24f. The hanging stock 14c-14f similarly move downward along the hanger 24, until each of the hanging stock 14c-14f is halted by the item in front of it, so that the length of the hanger 24 nearest the loading end 24a is vacated. As the remaining hanging stock 14b-f are similarly removed from the hanger 24, the space between the hanging stock 14f and the latch 26 increases until, finally, the hanging stock 14f is removed and the hanger 24 is emptied.

Restocking of the gravity feed system, which can be performed whether or not hanging stock 14 is already threaded on the hanger 24, requires that the hanger 24 be decoupled from the latch 26. To accomplish this, the hanger 24 is manipulated in reverse order of the steps described above for coupling the hanger 24 to the latch 26, as depicted in FIGS. 6-10 (also taken in reverse order of presentation). A force is exerted on the hanger 24 so that the crosspiece 24e and endpiece 24d slide within the latch 26 and the endpiece 24d contacts the horizontal portion of the load tab 26c of the latch 26. The hanger 24 is then rotated about the endpiece 24d so that the cross piece is lifted clear of the face and passes through the gap between the load tab 26c and the restraining tab 26b. The hanger 24 may then be moved so that the endpiece 24d slides within the latch 26 and emerges in the gap between the load tab 26c and the restraining tab 26b, at which point the hanger 24 may be moved away from the latch 26 so that the endpiece 24d passes between the load tab 26c and the restraining tab 26b and the hanger 24 is separated from the latch 26.

Once the hanger 24 is decoupled from the latch 26, the previously described technique for loading the hanger 24 with hanging stock 14 is repeated in order to restock the hanger 24. In the event that all hanging stock 14 previously loaded on the hanger 24 has been removed (via the dispensing end 24b of the hanger 24), an entirely new set of hanging stock 14 is threaded onto the hanger 24 for display and dispensing. If hanging stock 14 from the last loading task remains on the hanger 24, fewer items of the hanging stock 14 may be loaded, but the technique for loading the hanger 24 does not change.

As loading end 24a of the hanger 24 is the end at which the newer hanging stock 14 is loaded onto the hanger 24, the older hanging stock 14, which already resides on the hanger 24, will necessarily be placed at the fore of the gravity feed system once the hanger 24 is recoupled with the latch 26. The configuration of the hanger 24 and the loading technique employed with it thus addresses a problem commonly encountered in the display and sale of consumer goods via conventional display systems: the presentation of goods so that older items are presented to customers and newer items are not constantly placed at the fore of the display, ensuring cycling of inventory. Utilizing the rear-loading technique demonstrated by the embodiment shown in FIG. 4, an individual performing a restocking task need not reposition or remove older inventory prior to inserting newer inventory into a display. The threading movement described above automatically places newer inventory at the rear of each hanger 24 and presents the older inventory to the customer, eliminating an entire subset of movements normally involved in restocking tasks.

The hanger 24 and latch 26 can be fabricated of any material that is consistent with the uses described above. For example, each of the hanger 24 and the latch 26 could be fabricated from one or more plastic or metal materials. Also, the latch 26 could be fabricated from a plastic material and the housing could be fabricated from a metal, or vice versa.

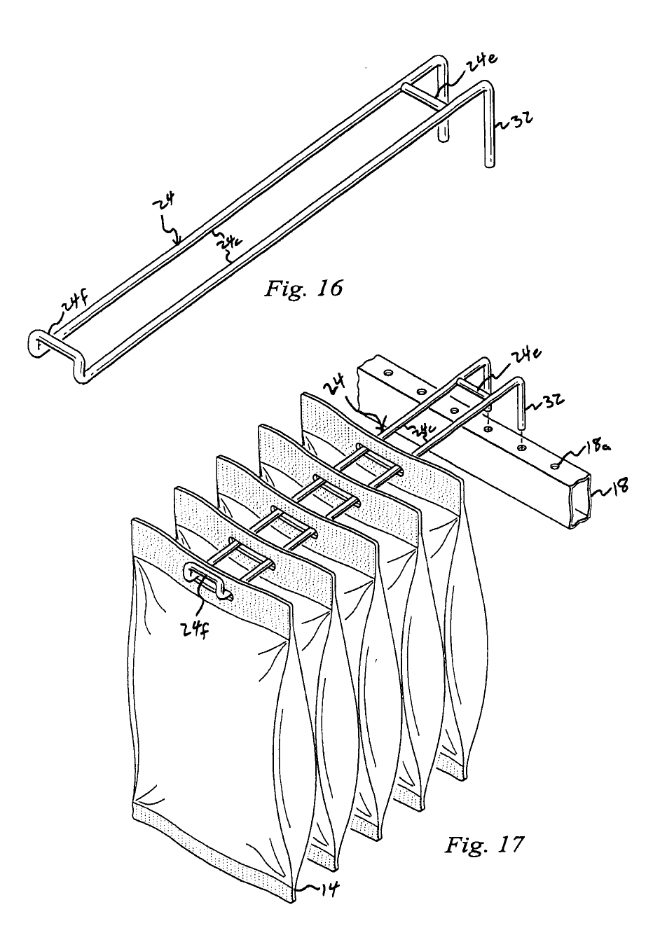

Variations may be made in the foregoing without departing from the scope of the invention. For instance, the embodiment shown in FIGS. 16 and 17 incorporates integral mounting members 32 into the hanger 24, allowing for adjustment of the position of the hanger 24 along the crossbeam 18 every time the hanger 24 is decoupled from the crossbeam 18.

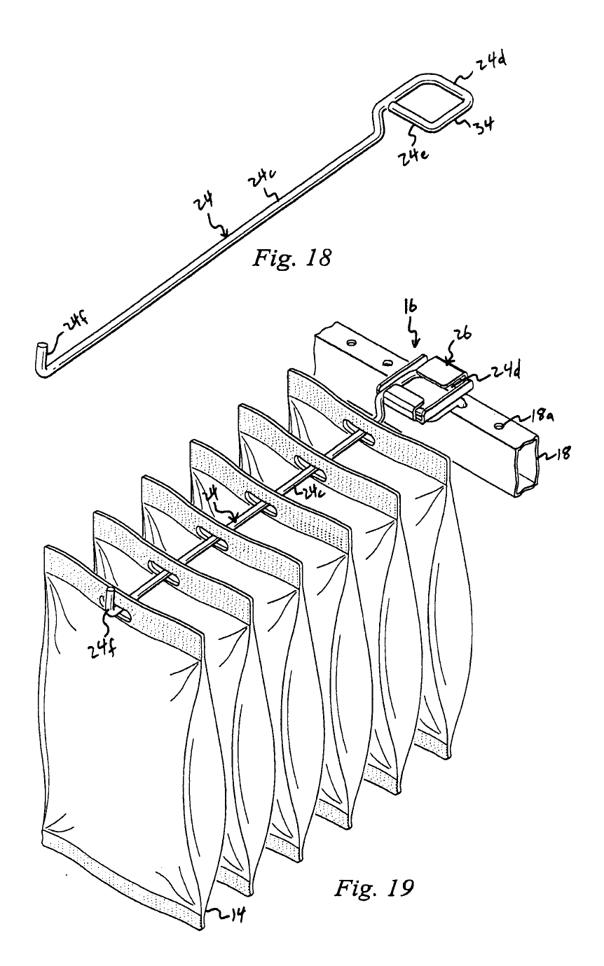

Another embodiment, illustrated in FIGS. 18 and 19, possesses only a single rod 24c for the display of smaller or lighter hanging stock 14. The crosspiece 24e and endpiece 24d of this modified version of the hanger 24 are joined by a connecting rod 34, but perform the same functions as their counterparts in the embodiment described in detail above and illustrated in FIGS. 1-15. In some versions of this embodiment, crosspiece 24e, endpiece 24d and connecting rod 34 may be formed from the same continuous member as the rod 24c.

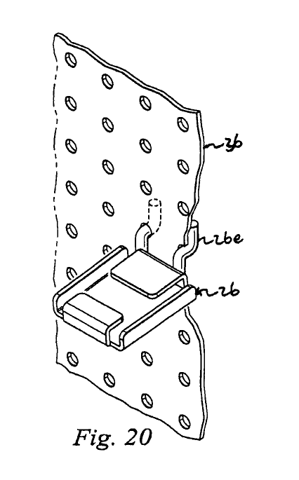

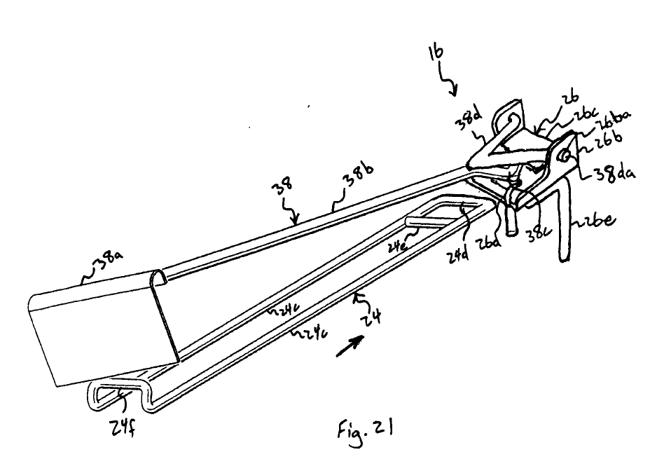

A further embodiment of the gravity feed hanger assembly includes a modified latch 26, shown in FIG. 20, that is configured to be coupled to a vertical, rather than a horizontal, surface 36. In some such embodiments, the mounting members 26e may extend to the rear of the latch 26 and are suitable for use with a pegboard, such as a standard 2″ center layout.

In yet other embodiments, such as that illustrated in FIGS. 21-23, the gravity feed hanger assembly 16 includes the additional element of a barcode display 38. The barcode display 38 includes a barcode mount 38a that is attached to a barcode rod 38b. The barcode mount 38a may be integral to the barcode rod 38b or removably coupled to the barcode rod 38b. The end of the barcode rod 38b opposite the barcode mount 38a includes a prop point 38c, which angles downward and then back upward, ending generally at the plane defined by the barcode rod 38b. This embodiment further includes a generally V-shaped hinge 38d, the apex of which joins the barcode display 38 at the joint between the barcode rod 38b and the prop point 38c. The hinge 38d is substantially parallel to the barcode rod 38b. Pivot members 38da extend from the ends of the hinge 38d in directions opposite one another and perpendicular to the barcode rod 38b. In some such embodiments, portions of the side tabs 26b of the latch 26 are enlarged and voids 26ba are formed therein to receive the pivot members 38da. When coupled with the latch 26 and in its resting position, the barcode display 38 is propped up at an angle that is substantially horizontal by the engagement of the prop point 38c with the top of the restraining tab 26d, as shown in FIG. 23.

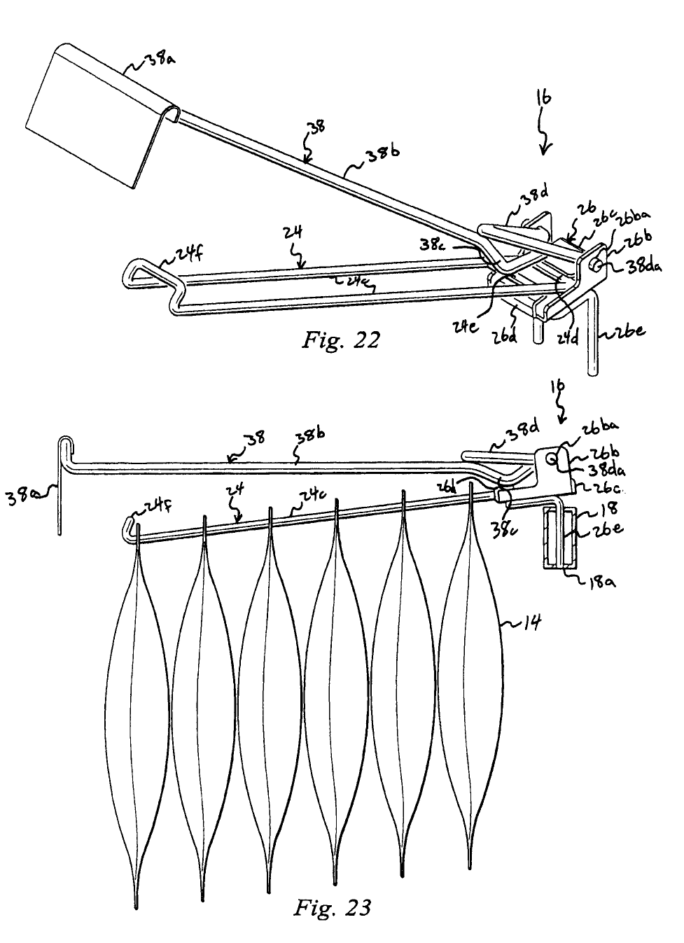

In such embodiments, the hanger 24 may be coupled with and decoupled from the latch 26 in the manner described in detail above, despite the presence of the barcode display 38. As the loading end 24a of the hanger 24 approaches the gap between the load tab 26c and the restraining tab 26b, the endpiece 24d contacts the front of the prop point 38c, as shown in FIG. 21. As the hanger 24 is moved closer to and inserted into the latch 26, the angle of the prop point 38c translates the force exerted by the endpiece 24d into upward movement of the barcode display 38, which rotates about the hinge 38d to create clearance between the prop point 38c and the restraining tab 26d for the endpiece 24d, as shown in FIG. 22. Once the endpiece 24d clears the prop point 38c, the barcode display 38 lowers back to its resting point and the endpiece 24d enters the gap between the load tab 26c and the restraining tab 26b. This process is repeated as the crosspiece 24e of the hanger 24 similarly enters the latch 26 and contacts the prop point 38c, so that the hanger 24 is coupled with the latch 26 and the gravity feed hanger assembly 16 is fully assembled and installed.

The hanger 24 is similarly detached from the latch 26 in this embodiment in the manner described in detail above. As the loading end 24a of the hanger 24 is removed from the latch 26 the crosspiece 24e and the endpiece 24d, in turn, are pressed against the back of the prop point 38c and force the barcode display 38 upward. During both the insertion and the removal of the hanger 24, the natural gripping position of the user's arm or hand may result in contact with and assistance in actuating the barcode display 38.

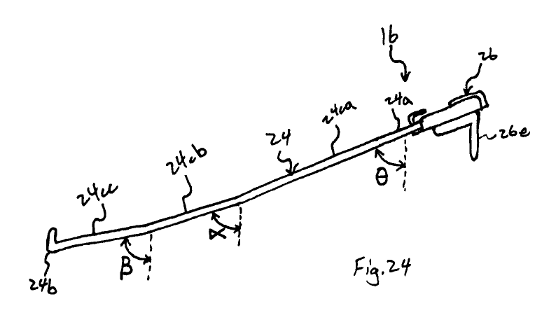

In still other embodiments, such as that depicted in FIG. 24, the gravity feed hanger assembly 16 is similar to the gravity feed hanger assembly 16 depicted in FIGS. 1-15 and contains substantially the same parts, which are given the same reference numerals. These embodiments of the gravity feed hanger assembly 16 include a non-linear hanger 24 which includes sections 24ca, 24cb and 24cc, each of which is substantially linear. The section 24ca extends substantially half of the length of the hanger 24, from the loading end 24a toward the center of the hanger 24, at an angle that is less than horizontal. The angle θ between the mounting members 26e and the hanger 24 is thus less than 90 degrees. The section 24cb extends from the section 24ca, toward the dispensing end 24b of the hanger 24, at a less steep angle than that of the section 24ca, so that an angle \acute{α} between the section 24cb and the mounting members 26e is greater than the angle θ. The section 24cc extends from the section 24cb, and forms the dispensing end 24b of the hanger 24, at less steep angle than that of the section 24cb, so that an angle β between the section 24cc and the mounting members 26e is greater than the angle \acute{α}. As described above, the hanging stock 14 are subjected to a constant downward force that pulls them along the hanger 24, toward the dispensing end 24b. The structure of the hanger 24 in the embodiment shown in FIG. 24 reduces the amount of force exerted on the foremost items of hanging stock 14 by trailing items of the hanging stock 14 near the dispensing end 24b of the hanger 24 by diminishing the potential for movement along the hanger 24 due to gravity.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims.

1.-17. (canceled)

18. A method, comprising:
removably coupling a hanger to a latch at a first end of the hanger;
stocking the hanger, comprising:
removing the hanger from the latch while the latch remains coupled to a support member;
threading an item of hanging stock onto the hanger via the first end; and
recoupling the hanger to the latch while the latch remains coupled to the support member; and
extending the hanger from the latch at an angle that is less than the horizontal, so that the hanging stock is urged by gravity toward a second end of the hanger.

19. The method of claim 18 further comprising:
retaining the hanging stock at the second end of the hanger; and
enabling the controlled dispensing of the hanging stock by retaining the hanging stock at a tip of the second end of the hanger so that the hanging stock can be manipulated and removed from the second end.

20. The method of claim 18 further comprising coupling a display member to the latch.

21. The method of claim 18 wherein coupling the display member to the latch comprises hingedly coupling the display member to the latch; and
wherein the method further comprises actuating the display member by coupling and decoupling the hanger and latch.

22. The method of claim 18 further comprising extending from the latch a mounting member by which the device is removably coupled to a support member of the display.

23. The method of claim 18 further comprising adjusting the position of the device within the display by decoupling the latch from the display and recoupling the latch to the display in a different location.

24. The method of claim 18 further comprising aligning freestanding hanging stock so that the hanger may be threaded through multiple items of the hanging stock in one continuous motion.

25. The method of claim 18 wherein the hanger includes a friction-reducing coating.

26. The method of claim 18 wherein the hanger is stabilized against lateral movement while the hanger is coupled to the latch.

27. The method of claim 18 wherein the hanger is stabilized against vertical movement while the hanger is coupled to the latch.

28. A system, comprising:
means for removably coupling a hanger to a latch at a first end of the hanger;
means for removing the hanger from the latch while the latch remains coupled to a display;
means for recoupling the hanger to the latch while the latch remains coupled to the display; and
means for extending the hanger from the latch at an angle that is less than horizontal, so that the hanging stock is urged by gravity toward a second end of the hanger.

29. The system of claim 28 further comprising means for stabilizing the hanger against lateral movement while the hanger is coupled to the latch wherein the latch comprises side tabs that extend upward from the side edges of the base.

30. The system of claim 28 further comprising means for stabilizing the hanger against vertical movement while the hanger is coupled to the latch.

31. (canceled)
